(19) United States
(12) Patent Application Publication
(10) Pub. No.: US 2002/0074241 A1
(43) Pub. Date: Jun. 20, 2002

(54) Apparatus and method for electrolysis of beverages

(76) Inventor: Shinichi Natsume, Shinshiro-shi (JP)

Correspondence Address: SQUIRE, SANDERS & DEMPSEY L.L.P, 600 HANSEN WAY, PALO ALTO, CA, 94304-1043, US

(21) Appl. No.: 10/028,578

(22) Filed: Dec. 19, 2001

Related U.S. Application Data
(60) Provisional application No. 60/257,535, filed on Dec. 20, 2000.

(51) Int. Cl. C02F 1/461

(52) U.S. Cl. 205/688; 205/746; 205/770; 204/263

(57) ABSTRACT

An apparatus for electrolysis of beverages. The apparatus comprises an electrolysis chamber for oxidizing and reducing beverages; a first pump coupled to the electrolysis chamber for pumping out the oxidized beverage; and a second pump coupled to the electrolysis chamber for pumping out the reduced beverage. The electrolysis chamber may further comprise one or more neutral, anion or cation membranes.

### PRIORITY REFERENCE TO PRIOR APPLICATIONS

This application claims benefit of and incorporates by reference patent application Ser. No. 60/257,535, entitled “System and Method for Electrolysis of Drinking Water, Liquids Containing AntiOxidants, Alcoholic and Non-Alcoholic Beverages,” filed on Dec. 20, 2000, by inventor Shinichi Natsume.

### TECHNICAL FIELD

This invention relates generally to electrolysis, and more particularly, but not exclusively, provides a system and method for enhancement of beverages via electrolysis.

### BACKGROUND

An electrolysis chamber comprises an anode and cathode that enables electrolysis of water. The anode at the anode side (positive side) of the electrolysis chamber generates O₂ from OH⁻ water and positively charged ions, thereby increasing the amount of H⁺ and decreasing the amount of OH⁻ thus turning the resulting water acidic.

The cathode at the cathode side (negative side) of the electrolysis chamber generates H₂ from Hydrogen ions (H⁺) and negatively charged ions, thereby decreasing the H⁺ and turning the resulting water alkaline. Accordingly, electrolysis can alter the pH of water without the use of chemical additives.

### SUMMARY

The present invention provides a system for the enhancement of beverages, such as drinking water, soft drinks, mineral water, juices, milk, coffee tea, liquids containing anti-oxidants, alcoholic and nonalcoholic beverages, etc., via electrolysis. Electrolyzed beverages, such as electrolyzed fruit juices, have enhanced flavor. Further, electrolysis of beverages increases the effectiveness of anti-oxidants in the beverages.

The system comprises an electrolysis chamber coupled to one or more beverage input sources and to one or more beverage output devices, such as bar taps or other types of beverage dispensers. The electrolysis chamber comprises a cathode, anode and optionally a membrane. The membrane may be a neutral membrane enabling both positive and negative ions and other molecules to pass through it, a cation exchange membrane enabling only positive ions to pass through it, or an anion exchange membrane enabling only negative ions to pass through it.

The system further comprises pumps that pump one or more beverages into the electrolysis chamber, in which the one or more beverages can be electrolyzed (e.g., reduced and/or oxidized). The system further comprises pumps that pump out the electrolyzed beverage(s) to a dispenser or container. In an embodiment of the invention, the system does not include pumps on the dispenser side if the input pressure generated by the input pump(s) is sufficient.

In an embodiment of the invention, it is possible to increase the mineral content of a beverage by using an electrolysis chamber having a cation membrane and/or a neutral membrane. For example, pumps may input a beverage into the cathode section and mineral water or other liquid having mineral into the anode section. Positively charged minerals then pass through the cation membrane to cathode section, thereby increasing the mineral density of the beverage at the cathode section.

The present invention further provides a method for electrolysis of beverages. The method comprises injecting one or more beverages into an electrolysis chamber having an anode and cathode; applying a current to the anode and cathode of the chamber; and pumping out the electrolyzed beverage to a dispenser. If the electrolysis chamber includes a membrane between the cathode and anode sections, the reduced and oxidized beverage may be pumped out separately to separate dispensers or containers.

Therefore, the system and method advantageously enhances beverages via electrolysis.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating an electrolysis system in accordance with an embodiment of the present invention;

FIG. 2 is a block diagram illustrating an electrolysis chamber in accordance with a first embodiment;

FIG. 3 is a block diagram illustrating an electrolysis chamber in accordance with a second embodiment;

FIG. 4 is a block diagram illustrating an electrolysis chamber in accordance with a third embodiment;

FIG. 5 is a block diagram illustrating an electrolysis chamber in accordance with a fourth embodiment;

FIG. 6 is a block diagram illustrating an electrolysis chamber in accordance with a fifth embodiment;

FIG. 7 is a block diagram illustrating an electrolysis chamber in accordance with a sixth embodiment; and

FIG. 8 is a block diagram illustrating an electrolysis chamber in accordance with a seventh embodiment.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

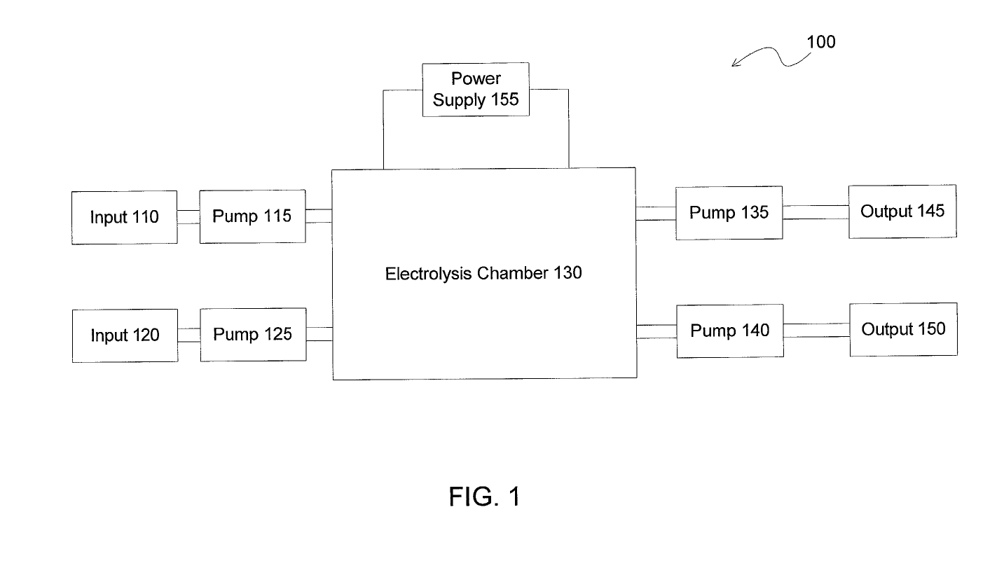

FIG. 1 is a block diagram illustrating an electrolysis system 100 in accordance with an embodiment of the present invention. System 100 comprises an electrolysis chamber 130 powered by a power supply 155. Beverages are injected into chamber 130 from input 110 and input 120 via pumps 115 and 125 respectively. In one embodiment, input 110 and input 120 supply different beverages to chamber 130. In another embodiment, input 110 and input 120 comprises a single beverage source and supplies one beverage to chamber 130.

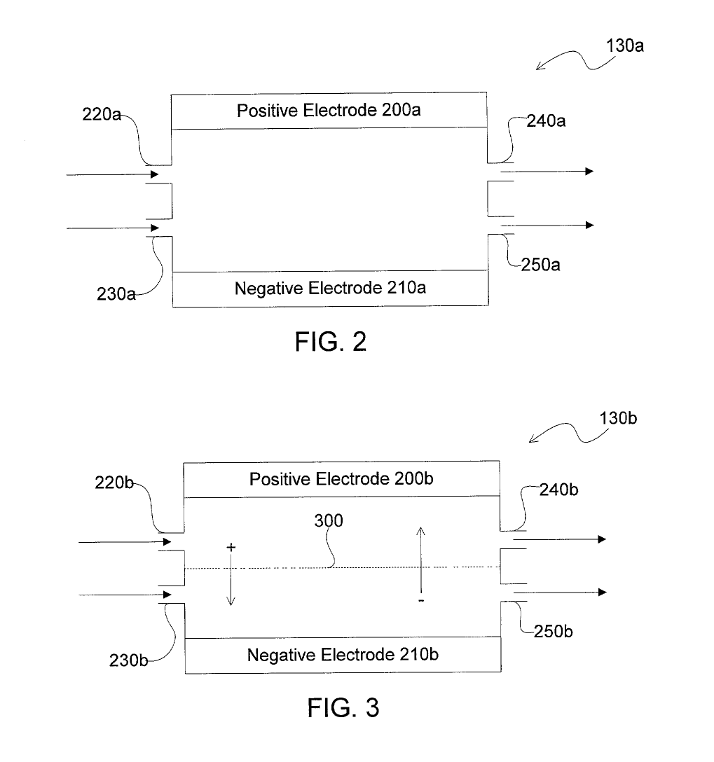

Electrolysis chamber 130 electrolyzes beverages injected into the chamber. Various embodiments of chamber 130 will be discussed in further detail in conjunction with FIG. 2 to FIG. 8. After electrolysis, the beverages are pumped into output 145 and output 150 via pump 135 and pump 140 respectively. In an embodiment, output 145 and 150 comprise containers for storing electrolyzed beverages. In another embodiment, output 145 and output 150 comprise dispensers for dispensing electrolyzed beverages. In an embodiment of the invention, a substance, such as vitamins, may be added to the beverages before injection into the chamber 130 (and therefore before electrolysis) or after exiting the chamber 130 (and therefore after electrolysis). Further, in another embodiment, system 100 does not include or may not use pumps 135 and 140 if pumps 115 and 125 generate sufficient input pressure.

FIG. 2 is a block diagram illustrating an electrolysis chamber 130a in accordance with a first embodiment. It is noted that the chambers 130b-130g described below are some of the possible embodiments of the chamber 130 that is shown in FIG. 1. The chamber 130a comprises a positive electrode 200a, a negative electrode 210a, entrance piping 220a and 230a, and exit piping 240a and 250a. A beverage is injected into chamber 130a via piping 220a and 230a. During electrolysis of the beverage, positive electrode 200a oxidizes the beverage and the negative electrode 210a reduces the beverage. Accordingly, oxidation and reduction of a beverage can be done simultaneously and the pH of the beverage may remain mostly unchanged. After electrolysis, the oxidized and reduced beverage exits the chamber 130a via piping 240a and 250a respectively.

Electrolysis of beverages in chamber 130a leads to enhanced flavor in beverages, such as fruit juice for example. Further, electrolysis of beverages in chamber 130a causes increased effectiveness of antioxidants within the beverage.

FIG. 3 is a block diagram illustrating an electrolysis chamber 130b in accordance with a second embodiment. The chamber 130b comprises a positive electrode 200b, a negative electrode 210b, a neutral membrane 300, entrance piping 220b and 230b, and exit piping 240b and 250b. Membrane 300 is located approximately midway between positive electrode 200b and negative electrode 210b, thereby dividing the chamber 130b into an oxidation chamber adjacent to the positive electrode 200b and a reduction chamber adjacent to the negative electrode 210b. Membrane 300 may be composed of non-woven cloth or unglazed ceramic.

Beverages injected to into the chamber 130b adjacent to the positive electrode 200b are oxidized and beverages injected into the chamber 130b adjacent to the negative electrode 210b are reduced. As membrane 300 somewhat separates the reduction and oxidation chambers within electrolysis chamber 130b, mostly oxidized beverages will exit via piping 240b and mostly reduced beverages will exit via piping 250b. The reduced and oxidized beverage can be dispensed and/or stored separately.

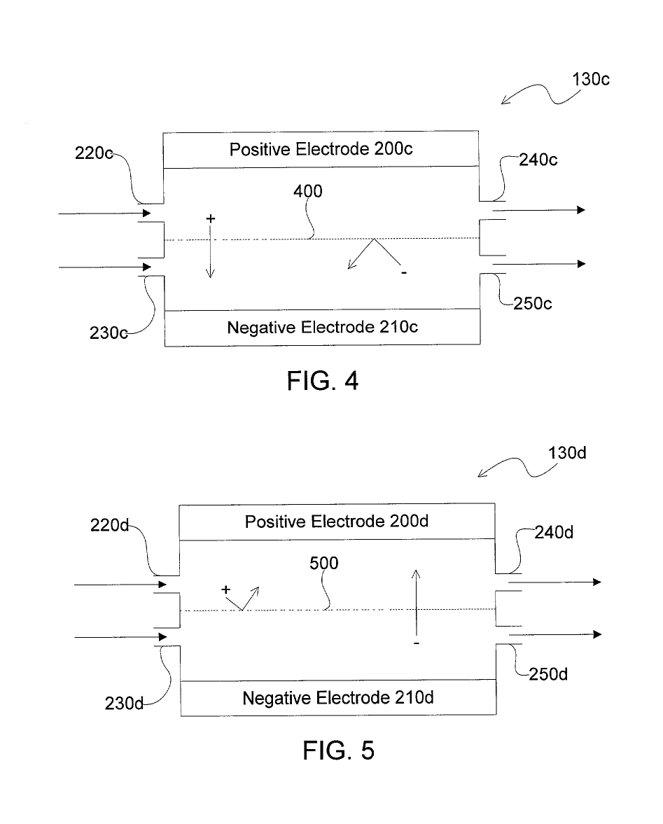

FIG. 4 is a block diagram illustrating an electrolysis chamber 130c in accordance with a third embodiment. The chamber 130c comprises a positive electrode 200c, a negative electrode 210c, a cation membrane 400, entrance piping 220c and 230c, and exit piping 240c and 250c. Membrane 400 is located approximately midway between positive electrode 200c and negative electrode 210c, thereby dividing the chamber 130c into an oxidation chamber adjacent to the positive electrode 200c and a reduction chamber adjacent to the negative electrode 210c. Membrane 400 may be made of a fluorine polymer and other materials.

Beverages injected to into the chamber 130c adjacent to the positive electrode 200c are oxidized and beverages injected into the chamber 130c adjacent to the negative electrode 210c are reduced. As membrane 400 is a cation membrane, membrane 400 is permeable to positive ions but impermeable to negative ions. As positive ions will be deflected from positive electrode 200c and attracted to negative electrode 210c, positive ions will tend to migrate from the area adjacent to the positive electrode 200c through the membrane 400 towards the negative electrode 210c. Further, beverages injected into the reduction chamber of the electrolysis chamber 130c can be reduced without lowering the quality of the beverage. Reduced beverages having less positive ions may exit via piping 250c and oxidized beverages having more positive ions may exit via piping 240c. The electrolyzed beverages may then be separately dispensed and/or stored.

In an embodiment of the invention, mineral water or other liquid containing positive ions is injected into the oxidation chamber of electrolysis chamber 130c while a beverage to be altered (also referred to as an “original beverage”) is injected into the reduction chamber of electrolysis chamber 130c. Positively charged minerals from the oxidation chamber are attracted to the negative electrode 210c and repelled from the positive electrode 200c. As the cation membrane 400 enables positive ions to cross, the positively charged minerals permeate across the membrane 400 into the reduction chamber, thereby increasing the mineral density of the original beverage while simultaneously reducing the original beverage. After electrolysis, the mineral-enhanced beverage can be dispensed from piping 250c (for drinking or storage) and the diluted mineral water may be dispensed from piping 240c.

FIG. 5 is a block diagram illustrating an electrolysis chamber 130d in accordance with a fourth embodiment. The chamber 130d comprises a positive electrode 200d, a negative electrode 210d, an anion membrane 500, entrance piping 220d and 230d, and exit piping 240d and 250d. Membrane 500 is located approximately midway between positive electrode 200d and negative electrode 210d, thereby dividing the chamber 130d into an oxidation chamber adjacent to the positive electrode 200d and a reduction chamber adjacent to the negative electrode 210d.

Beverages injected to into the chamber 130d adjacent to the positive electrode 200d are oxidized and beverages injected into the chamber 130d adjacent to the negative electrode 210d are reduced. As membrane 500 is an anion membrane, membrane 500 is permeable to negative ions but impermeable to positive ions. As negative ions will be attracted to positive electrode 200d and repelled from negative electrode 210d, negative ions will tend to migrate from the area adjacent to the negative electrode 210d through the membrane 500 towards the positive electrode 200d. Further, beverages injected into the oxidation chamber of the electrolysis chamber 130d can be oxidized without lowering the quality of the beverage. Reduced beverages having additional negative ions may exit via piping 250d and oxidized beverages having less negative ions may exit via piping 240d. The electrolyzed beverages may then be separately dispensed and/or stored.

In an embodiment of the invention, a liquid containing negative ions is injected into the reduction chamber of electrolysis chamber 130d while a beverage to be altered (also referred to as an “original beverage”) is injected into the oxidation chamber of electrolysis chamber 130d. Negatively charged ions from the reduction chamber are attracted to the positive electrode 200d and repelled from the negative electrode 210d. As the anion membrane 500 enables negative ions to cross, the negatively charged ions permeate across the membrane 500 into the oxidation chamber, thereby increasing the negative ion density of the original beverage while simultaneously oxidizing the original beverage. After electrolysis, the oxidized beverage can be dispensed from piping 240d (for drinking or storage) and the reduced liquid may be dispensed from piping 250d.

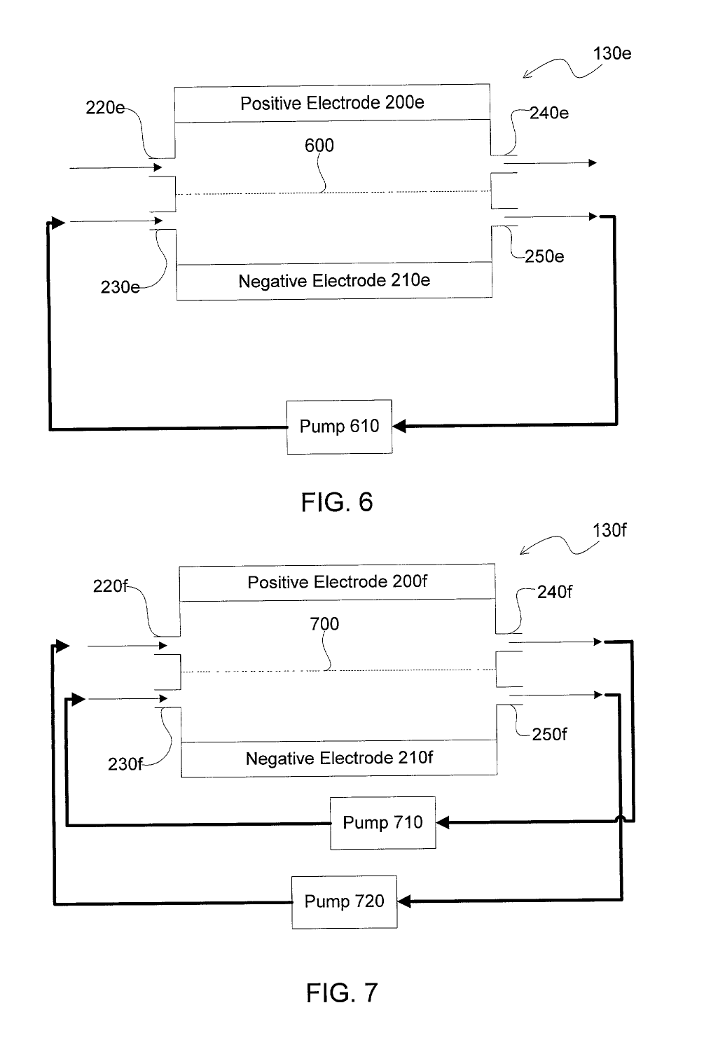

FIG. 6 is a block diagram illustrating an electrolysis chamber 130e in accordance with a fifth embodiment. The chamber 130e comprises a positive electrode 200e, a negative electrode 210e, a membrane 600, entrance piping 220e and 230e, exit piping 240e and 250e, and a pump 610. Membrane 600 may be a neutral, anion or cation membrane and is located approximately midway between positive electrode 200e and negative electrode 210e, thereby dividing the chamber 130e into an oxidation chamber adjacent to the positive electrode 200e and a reduction chamber adjacent to the negative electrode 210e.

Beverages injected to into the chamber 130e adjacent to the positive electrode 200e are oxidized and beverages injected into the chamber 130e adjacent to the negative electrode 210e are reduced. Further, beverages injected into the oxidation chamber of the electrolysis chamber 130e can be oxidized without lowering the quality of the beverage and beverages injected in the reduction chamber can be reduced without lowering the quality of the beverage.

Pump 610 pumps reduced beverages out of the reduction chamber via piping 250e and recirculates the reduced beverages to the reduction chamber via piping 230e, thereby enabling circulating electrolysis. In another embodiment of the invention, the pump 610 pumps out oxidized beverages from the oxidation chamber via piping 240e and recirculates the oxidized beverages to the oxidation chamber via piping 220e. In another embodiment, chamber 130e may comprise a first pump for circulating reduced beverages to the reduction chamber and a second pump for circulating oxidized beverages to the oxidation chamber.

FIG. 7 is a block diagram illustrating an electrolysis chamber 130f in accordance with a sixth embodiment. The chamber 130f comprises a positive electrode 200f, a negative electrode 210f, a membrane 700, entrance piping 220f and 230f, exit piping 240f and 250f, and pumps 710 and 720. Membrane 700 may be a neutral, anion or cation membrane and is located approximately midway between positive electrode 200f and negative electrode 210f, thereby dividing the chamber 130f into an oxidation chamber adjacent to the positive electrode 200f and a reduction chamber adjacent to the negative electrode 210f.

Beverages injected to into the chamber 130f adjacent to the positive electrode 200f are oxidized and beverages injected into the chamber 130f adjacent to the negative electrode 210f are reduced. Further, beverages injected into the oxidation chamber of the electrolysis chamber 130f can be oxidized without lowering the quality of the beverage and beverages injected in the reduction chamber can be reduced without lowering the quality of the beverage.

Pump 710 pumps oxidized beverages out of the oxidation chamber via piping 240f and circulates the oxidized beverages to the reduction chamber via piping 230f, thereby enabling alternating oxidation/reduction. Pump 720 pumps reduced beverages out of the reduction chamber via piping 250f and circulates the reduced beverages to the oxidation chamber via piping 220f, thereby further enabling alternating oxidation/reduction.

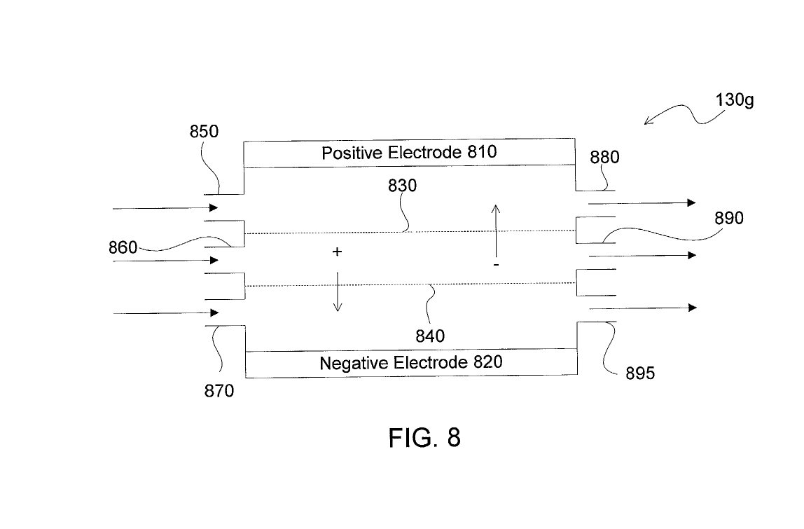

FIG. 8 is a block diagram illustrating an electrolysis chamber 130g in accordance with a seventh embodiment. Chamber 130g comprises a positive electrode 810, negative electrode 820, a first membrane 830, a second membrane 840, entrance piping 850, 860, and 870, and exit piping 880, 890, and 895. Membrane 830 may be a neutral or cation membrane while membrane 840 may be an anion or neutral membrane. Membrane 830 may be located within chamber 130g midway between entrance piping 850 and 860 and running parallel to positive electrode 810 thereby forming an oxidation chamber between positive electrode 810 and membrane 830. Membrane 840 may be located within chamber 130g midway between entrance piping 860 and 870 and running parallel to negative electrode 820 thereby forming a reduction chamber between negative electrode 820 and membrane 840.

Identical or different beverages may be injected into chamber 130g via entrance piping 850, 860 and 870. Injected beverages may then be electrolyzed within chamber 130g. Beverages injected into chamber 130g via entrance piping 850 will be oxidized and exit via piping 880 for dispensing and/or storage. Beverages injected into chamber 130g via piping 870 will be reduced and exit via piping 895 for dispensing and/or storage. Beverages injected into chamber 130g via entrance piping 860 will be deionized as positive ions will be repelled from positive cathode 810 and attracted to negative electrode 820 and cross membrane 840. Further, negative ions will cross membrane 830 towards positive electrode 810 and away from negative electrode 820. The deionized beverage exits the chamber 130g via piping 890 for dispensing and/or storage.

The foregoing description of the embodiments of the present invention is by way of example only, and other variations and modifications of the above-described embodiments and methods are possible in light of the foregoing teaching. The embodiments described herein are not intended to be exhaustive or limiting. The present invention is limited only by the following claims.

What is claimed is:

1. A method, comprising:
inputting a beverage into an electrolysis chamber;
electrolyzing the beverage; and
outputting the electrolyzed beverage from the electrolysis chamber.

2. The method of claim 1, wherein the electrolyzed beverage includes oxidized and reduced beverages.

3. The method of claim 2, wherein the oxidized and reduced beverages are output separately from the electrolysis chamber.

4. The method of claim 3, further comprising inputting a second beverage into the electrolysis chamber.

5. The method of claim 4, wherein the electrolysis chamber includes a cation membrane located between a positive electrode and a negative electrode of the chamber, wherein the second beverage includes mineral water and wherein the second beverage is input into the electrolysis chamber adjacent to the positive electrode of the chamber.

6. The method of claim 1, wherein the electrolysis chamber includes a membrane located approximately midway between a positive electrode and a negative electrode of the chamber.

7. The method of claim 6, wherein the membrane is neutral.

8. The method of claim 6, wherein the membrane is a cation membrane.

9. The method of claim 6, wherein the membrane is an anion membrane.

10. An apparatus, comprising:
an electrolysis chamber for oxidizing and reducing beverages;
a first pump coupled to the electrolysis chamber for pumping out the oxidized beverage; and
a second pump coupled to the electrolysis chamber for pumping out the reduced beverage.

11. The apparatus of claim 10, wherein the chamber further comprises a first membrane located between a positive electrode and a negative electrode of the electrolysis chamber.

12. The apparatus of claim 11, wherein the first membrane is a neutral membrane.

13. The apparatus of claim 11, wherein the first membrane is a cation membrane.

14. The apparatus of claim 11, wherein the first membrane is an anion membrane.

15. The apparatus of claim 11, further comprising
a third pump for pumping a first beverage into the electrolysis chamber adjacent to the positive electrode; and
a fourth pump for pumping a second beverage into the electrolysis chamber adjacent to the negative electrode.

16. The apparatus of claim 15, wherein the first beverage includes mineral water.

17. The apparatus of claim 15, wherein the electrolysis chamber further comprises a second membrane located between the positive electrode and the negative electrode, and the apparatus further comprises
a fifth pump for pumping a third beverage into the electrolysis chamber between the first and second membranes; and
a sixth pump for pumping out a deionized beverage from between the first and second membranes of the electrolysis chamber.

18. The apparatus of claim 11, wherein the electrolysis chamber further comprises a second membrane located between the positive electrode and the negative electrode, and the apparatus further comprises
a third pump for pumping a beverage into the electrolysis chamber adjacent to the positive electrode;
a fourth pump for pumping the beverage into the electrolysis chamber adjacent to the negative electrode;
a fifth pump for pumping the beverage into the electrolysis chamber between the first and second membranes; and
a sixth pump for pumping out a deionized beverage from between the first and second membranes of the electrolysis chamber.

19. An apparatus, comprising:
means for inputting a beverage into an electrolysis chamber;
means for electrolyzing the beverage; and
means for outputting the electrolyzed beverage from the electrolysis chamber.

20. An apparatus, comprising:
an electrolysis chamber for oxidizing and reducing beverages;
at least one pump coupled to the electrolysis chamber for pumping in beverages, the first pump capable to produce sufficient pressure to output, from the chamber, the oxidized and reduced beverages after oxidation and reduction respectively.

21. The apparatus of claim 20, wherein the chamber further comprises a first membrane located between a positive electrode and a negative electrode of the electrolysis chamber.

22. The apparatus of claim 21, wherein the first membrane is a neutral membrane.

23. The apparatus of claim 21, wherein the first membrane is a cation membrane.

24. The apparatus of claim 21, wherein the first membrane is an anion membrane.

25. The apparatus of claim 21, wherein the at least one pump comprises:
a first pump for pumping a first beverage into the electrolysis chamber adjacent to the positive electrode; and
a second pump for pumping a second beverage into the electrolysis chamber adjacent to the negative electrode.

26. The apparatus of claim 25, wherein the first beverage includes mineral water.

27. The apparatus of claim 25, wherein the electrolysis chamber further comprises a second membrane located between the positive electrode and the negative electrode, and the at least one pump further comprises a third pump for pumping a third beverage into the electrolysis chamber between the first and second membranes.

28. An oxidized beverage prepared by a process comprising:
inputting a beverage into an electrolysis chamber; and
electrolyzing the beverage;

29. A reduced beverage prepared by a process comprising:
inputting a beverage into an electrolysis chamber; and
electrolyzing the beverage.

30. A mineral-enhanced beverage prepared by a process comprising:
inputting a beverage into an electrolysis chamber, the chamber including a cation membrane located between a positive electrode and a negative electrode;
inputting mineral water into the chamber adjacent to the positive electrode; and
electrolyzing the beverage.
